(19) United States
(12) Patent Application Publication
(10) Pub. No.: US 2026/0360356 A1
(43) Pub. Date: Nov. 12, 2026

(54) APPLIANCE AND METHOD FOR OPERATING THE APPLIANCE BASED ON AUDIO INPUT

(71) Applicant: Haier US Appliance Solutions, Inc., Wilmington, DE (US)

(72) Inventor: Michael Goodman Schroeder, Crestwood, KY (US)

(21) Appl. No.: 19/203,749

(22) Filed: May 9, 2025

(51) Int. Cl. G10L 15/22

(52) U.S. Cl. CPC G10L 15/22; G10L 2015/223

(57) ABSTRACT

A method is for operating an appliance. The method includes sampling, via a microphone, an audio input. The method includes converting the audio input to a derived form. The method includes inputting the derived form into a model. The model assigns the derived form a vector embedding. The method includes matching the vector embedding to a control vector within a predetermined level of confidence. The method further includes executing an operation. The operation corresponds to the control vector.

### FIELD OF THE INVENTION

The present subject matter relates generally to appliances, and more particularly to refrigerators appliances configured for audio-based operation.

### BACKGROUND OF THE INVENTION

Refrigerator appliances generally include a cabinet that defines chilled chambers for receipt of food items for storage. One or more insulated, sealing doors are provided for selectively enclosing the chilled food storage chambers. The appliances may also be able to store and execute commands from a user.

Verbal commands from the user may be executed by one or more microprocessors or controllers of the appliances. The appliances may be configured to interpret “wake words” to execute an operation. However, operations may be limited to precise verbal commands of the user.

Accordingly, an appliance, or refrigerator appliance, which obviates one or more of the above-mentioned drawbacks would be beneficial. In particular, a refrigerator appliance that can listen for suggestive sounds to execute an operation would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method is for operating an appliance. The method includes sampling, via a microphone, an audio input. The method includes converting the audio input to a derived form. The method includes inputting the derived form into a model. The model assigns the derived form a vector embedding. The method includes matching the vector embedding to a control vector within a predetermined level of confidence. The method further includes executing an operation. The operation corresponds to the control vector.

In another exemplary aspect of the present disclosure, an appliance includes a cabinet, a microphone mounted to the cabinet, and a controller communicatively coupled with the microphone. The controller is configured to receive, via a microphone, an audio input, and convert the audio input to a derived form. The controller is further configured to input the derived form into a model. The model assigns the derived form a vector embedding. The controller is further configured to match the vector embedding to a control vector within a predetermined level of confidence. The controller is further configured to execute an operation. The operation corresponds to the control vector.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of an example refrigerator appliance according to one or more embodiments of the present subject matter.

FIG. 2 provides a front view of the refrigerator appliance of FIG. 1 with appliance doors in an open position.

FIG. 3 provides a flow chart of an example method of use of the refrigerator appliance of FIG. 1 according to one or more embodiments of the present subject matter.

FIG. 4 provides an example look-up table for the method of use of FIG. 3 according to the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

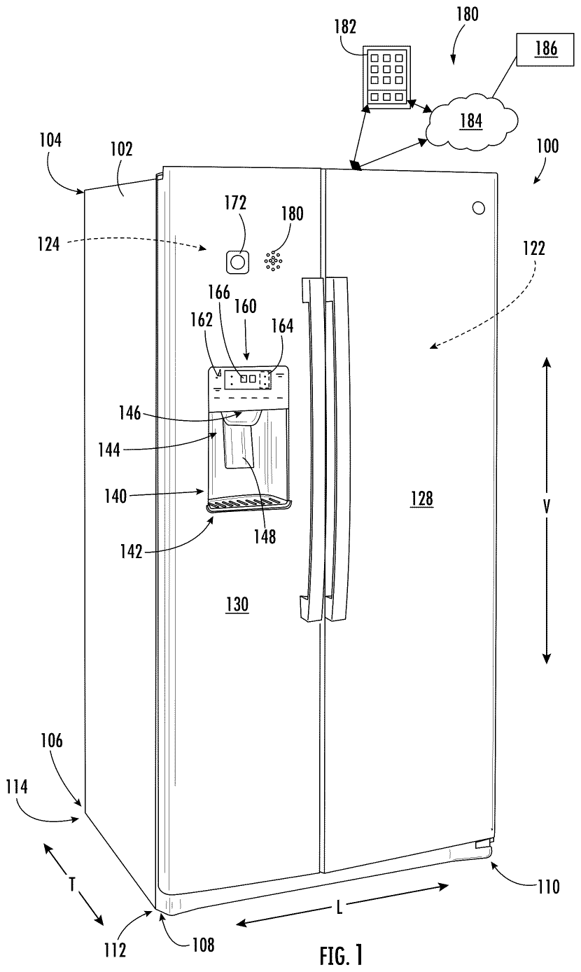

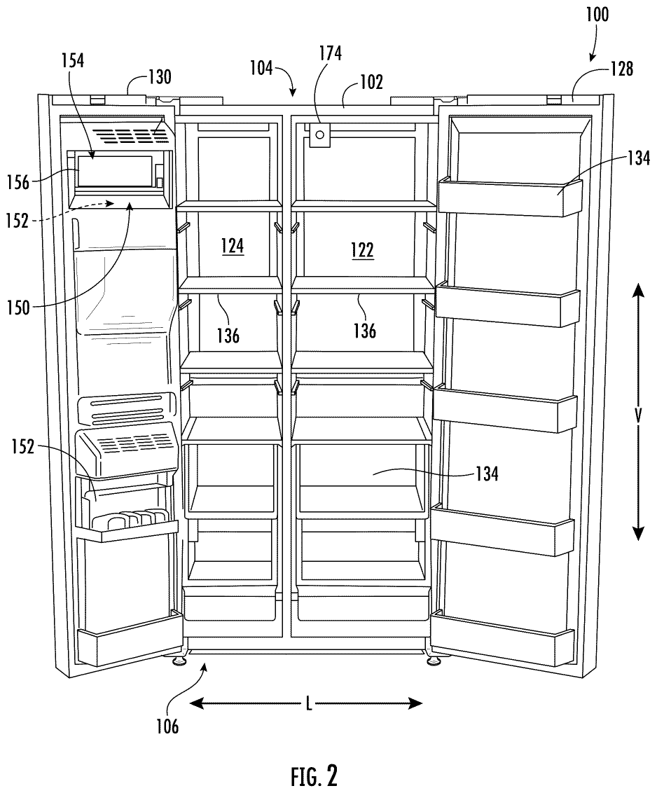

FIG. 1 provides a perspective view of an example refrigerator appliance 100 according to one or more embodiments of the present subject matter with doors 106 (described in more detail below) closed in FIG. 1. In FIG. 2, the doors 106 are open. The refrigerator appliance 100 defines a vertical direction V, a lateral direction L, and a transverse direction T, each mutually perpendicular to one another. As may be seen in FIGS. 1 and 2, refrigerator appliance 100 includes a cabinet 102 that extends between a top side 152, or top, and a bottom side 154, or bottom, along a vertical direction V, between a left side 144, or first side, and a right side 146, or second side, along the lateral direction L, and between a front side 148, or front, and a rear side 150, or back, along the transverse direction T.

Cabinet 102 defines a chilled chamber 160 for receipt of food items for storage. As used herein, the chamber may be “chilled” in that the chamber is operable at temperatures below room temperature, e.g., less than about seventy-five degrees Fahrenheit (75 °F). In particular, chilled chamber 160 may include a fresh food compartment (not labeled) and a freezer compartment 136. For example, fresh food compartment may be operable within a temperature range above the freezing point of water and below room temperature, such as between approximately thirty-three degrees Fahrenheit (33 °F) and approximately sixty degrees Fahrenheit (60 °F). Also, by way of example, freezer compartment 136 may be operable within a temperature range including temperatures less than thirty-two degrees Fahrenheit (32 °F), such as between approximately thirty degrees Fahrenheit (30 °F) and approximately negative six degrees Fahrenheit (−6 °F). For example, a temperature of fresh food compartment may be about forty degrees Fahrenheit (40 °F) or about forty-five degrees Fahrenheit (45 °F) and a temperature of freezer compartment 136 may be about fifteen degrees Fahrenheit (15 °F) or about twenty-five degrees Fahrenheit (25 °F).

Freezer compartment 136 and fresh food compartment may be separated by a thermally insulated partition (not labeled), as illustrated. The partition may be a vertical partition, e.g., the partition may extend along the vertical direction V. The thermally insulated partition may permit or enhance operation of fresh food compartment and freezer compartment 136 at distinct temperatures. One of ordinary skill in the art will recognize that chilled chamber 160 and the various portions thereof may be chilled by a sealed refrigeration system, such that chilled chamber 160, fresh food compartment, and/or freezer compartment 136 may be operable at or about the temperatures described above by providing chilled air from the sealed system. The structure and function of such sealed systems are understood by those of ordinary skill in the art and are not described in further detail herein for the sake of brevity and clarity.

Each of fresh food compartment and freezer compartment 136 of chilled chamber 160 may extend along the vertical direction V between the top side 152 and the bottom side 154 of cabinet 102. A front portion of chilled chamber 160 may define an opening for receipt of food items. Freezer compartment 136 may be positioned adjacent to fresh food compartment (e.g., along the lateral direction L). For example, each of fresh food compartment and freezer compartment 136 may extend from a bottom of chilled chamber 160 to a top of chilled chamber 160.

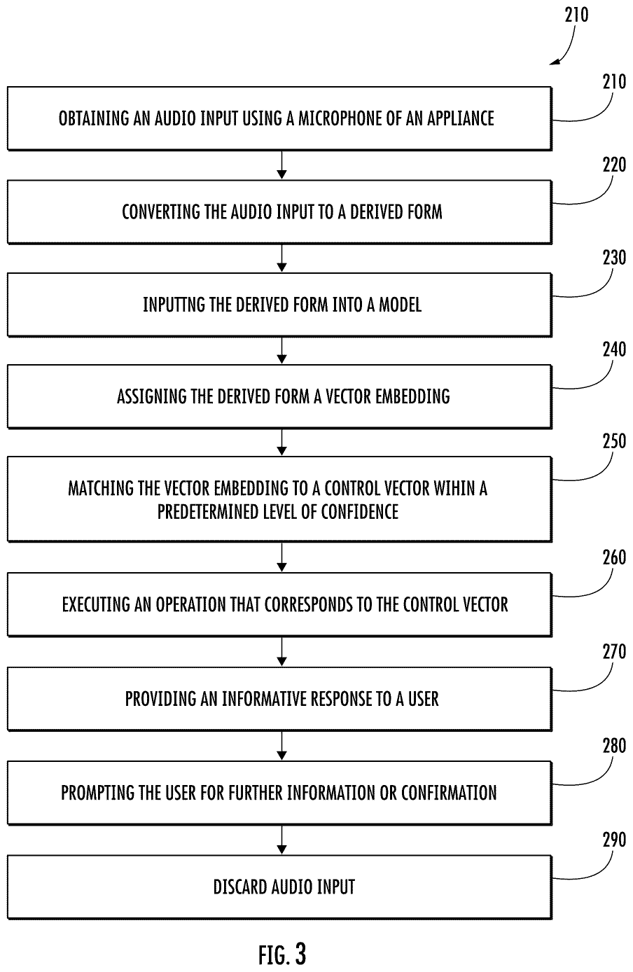

The refrigerator doors 106 may be rotatably mounted, e.g., hinged, to an edge of the cabinet 102 for selectively accessing fresh food compartment and freezer compartment 136, respectively, of chilled chamber 160 within cabinet 102. A hinge 142 may couple the door 106 to the cabinet 102. Refrigerator doors 106 may be mounted to cabinet 102 at or near front side 148 of chilled chamber 160 such that the door 106 rotates between a closed position (FIG. 1) and an open position (FIGS. 2 and 3). In the closed position of FIG. 1, doors 106 cooperatively enclose and seal chilled chamber 160. More specially, the freezer compartment 136 may be at least partially defined by the door 106 that is closed over the chilled chamber 160 on the first side 144. Additionally, one or more gaskets and other sealing devices, which are not shown but will be understood by one of ordinary skill in the art, may be provided to promote sealing between doors 106 and cabinet 102. In the open position of FIG. 2, doors 106 permit respective access to each of fresh food compartment and freezer compartment 136. The doors 106 may be generally mirrored, e.g., the overall shape and size of each door of the doors 106 may be the same, with possible internal variations such as a dispensing assembly 110. Moreover, although not specifically shown, doors 106 may be independently rotatable such that, e.g. the door 106 corresponding to the fresh food compartment may be in the open position while the door 106 corresponding to the freezer compartment 136 is in the closed position, or vice versa (as illustrated in FIG. 3).

Various storage components may be mounted within fresh food compartment and freezer compartment 136 to facilitate storage of food items therein as will be understood by those skilled in the art. In particular, the storage components may include various combinations of bins, drawers, and shelves mounted within fresh food compartment and freezer compartment 136. The bins 134, drawers (not labeled), and shelves 136 may be configured for receipt of food items (e.g., beverages and/or solid food items) and may assist with organizing such food items.

As may be seen in FIG. 1, refrigerator appliance 100 may include a dispensing assembly 110, or dispenser, positioned on the outside surface 108, or exterior side, of the door 106. The dispenser 110 may be for dispensing liquid water and/or ice. Dispensing assembly 110 may include a water dispenser 114 positioned on or mounted to an exterior portion of refrigerator appliance 100 (e.g., on one of doors 106). Dispensing assembly 110 may include an ice dispenser 112 for accessing ice. An actuating mechanism, shown as a paddle, may be mounted below the water dispenser 114 and/or the ice dispenser 112 for operating dispensing assembly 110. In alternative exemplary embodiments, any suitable actuating mechanism may be used to operate dispenser 110. For example, dispenser 110 may include a sensor (such as an ultrasonic sensor) or a button rather than the paddle. A user interface panel may be provided for controlling the mode of operation. For example, user interface panel (not labeled) may include a plurality of user inputs (not labeled), such as a water dispensing button and an ice-dispensing button, for selecting a desired mode of operation such as crushed or non-crushed ice.

The dispensing assembly 110 may be positioned on an exterior surface 108, or outside surface, of one of the doors 106 (e.g., the door 106 corresponding to the freezer compartment 136), at a predetermined elevation convenient for a user to access ice or water and enabling the user to access ice without the need to bend-over and without the need to open doors 106. In the exemplary embodiment, dispensing assembly 110 is positioned at a level that approximates the chest level of a user.

Appliance 100 may further include or be in operative communication with a processing device or a controller 164 that may be generally configured to facilitate appliance operation. In this regard, user interface panel, certain user input devices, a display, and the like may be in communication with controller 164 such that controller 164 may receive control inputs from user interface panel, may display information using the display, and may otherwise regulate operation of appliance 100. For example, signals generated by controller 164 may operate appliance 100, including any or all system components, subsystems, or interconnected devices, in response to the position of user interface panel and other control commands. User interface panel and other components of appliance 100 may be in communication with controller 164 via, for example, one or more signal lines or shared communication busses. In this manner, Input/Output (“I/O”) signals may be routed between controller 164 and various operational components of appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 164 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 164 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 164 may be operable to execute programming instructions or micro-control code associated with an operating cycle of appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 164 as disclosed herein is capable of and may be operable to perform any methods, method steps, or portions of methods as disclosed herein. For example, in some embodiments, methods disclosed herein may be embodied in programming instructions stored in the memory and executed by controller 164.

The memory devices may also store data that can be retrieved, manipulated, created, or stored by the one or more processors or portions of controller 164. The data can include, for instance, data to facilitate performance of one or more methods. The data can be stored locally (e.g., on controller 164) in one or more databases and/or may be split up so that the data is stored in multiple locations. In addition, or alternatively, the one or more database(s) can be connected to controller 164 through any suitable network(s), such as through a high bandwidth local area network (LAN) or wide area network (WAN). In this regard, for example, controller 164 may further include a communication module or interface that may be used to communicate with one or more other component(s) of appliance 100, controller 164, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring still to FIG. 1, a schematic diagram of an external communication system 180 will be described according to an exemplary embodiment of the present subject matter. In general, external communication system 180 is configured for permitting interaction, data transfer, and other communications between cooking appliance 100 and one or more external devices. For example, this communication may be used to provide and receive operating parameters, user instructions or notifications, performance characteristics, user preferences, or any other suitable information for improved performance of cooking appliance 100. In addition, it should be appreciated that external communication system 180 may be used to transfer data or other information to improve performance of one or more external devices or appliances and/or improve user interaction with such devices.

For example, external communication system 180 permits controller 164 of cooking appliance 100 to communicate with a separate device external to cooking appliance 100, referred to generally herein as an external device 182. As described in more detail below, these communications may be facilitated using a wired or wireless connection, such as via a network 184. In general, external device 182 may be any suitable device separate from cooking appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with cooking appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control cooking appliance 100, etc. In addition, external device 182 and remote server 186 may communicate with cooking appliance 100 to communicate similar information.

In general, communication between cooking appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with cooking appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

As illustrated in FIG. 1, refrigerator appliance 100 may further include one or more microphones 170 that are generally positioned and configured for monitoring sound around refrigerator appliance 100, e.g., within the room containing refrigerator appliance 100. For example, according to the illustrated embodiment, a single microphone 170 is mounted to refrigerator door 128 of refrigerator appliance 100. Microphone 170 is generally configured for monitoring sound, voice inputs from the user of refrigerator appliance 100, etc. As used herein, the terms microphone and the like are generally intended to refer to any suitable audio input, such as a microphone, an acoustic pickup, sound receiver/transmitter, or any of sound receiving device.

In addition, it should be appreciated that any suitable number, type, position, and configuration of microphones may be used while remaining within the scope of the present subject matter. For example, according to the illustrated embodiment, a single microphone 170 is mounted to refrigerator door 128 for monitoring sounds and voices around refrigerator appliance 100 (e.g., within the kitchen, dining room, etc.). As described herein, detected sounds and voices may be used to improve user interaction and control of refrigerator appliance 100. However, according to alternative embodiments, microphone 170 could be mounted to any other kitchen appliance or could be a standalone device that is in operative communication with refrigerator appliance 100 to provide feedback regarding a user interaction with refrigerator appliance 100.

As shown for example in FIG. 1, refrigerator appliance 100 may include a first camera 172 that is generally positioned and configured for obtaining images of the environment surrounding refrigerator appliance 100 during operation. Specifically, according to the illustrated embodiment, a single first camera 172 may be mounted to refrigerator door 128 or at any other suitable position for obtaining images in or around refrigerator appliance 100. Although a single first camera 172 is illustrated, it should be appreciated that refrigerator appliance 100 may include any suitable number of cameras positioned at any suitable location and orientation for obtaining useful images related to user interaction with refrigerator appliance 100. For example, the refrigerator appliance 100 may include a second camera 174 positioned, and aimed, within/at the chilled chambers 122, 124. In addition, it should be appreciated that each camera 172, 174 may include features for adjusting the field-of-view and/or orientation.

It should be appreciated that the images obtained by the cameras 172, 174 may vary in number, frequency, angle, resolution, detail, etc. in order to improve the clarity of the particular regions surrounding or within refrigerator appliance 100. In addition, according to exemplary embodiments, controller 164 (or any other suitable dedicated controller) may be communicatively coupled to first camera 172 and the second camera 174 and may be programmed or configured for analyzing the images obtained by the cameras 172, 174, e.g., in order to detect and analyze user interactions with refrigerator appliance 100. Moreover, it should be appreciated that controller 164 may be in operative communication with the remote server 186 (e.g., via the external network 180) for offloading images for remote analysis. Such analysis may be intended to detect user interactions with refrigerator appliance 100, e.g., as described in more detail below.

Now that the construction and configuration of refrigerator appliance 100 has been presented according to an exemplary embodiment of the present subject matter, an exemplary method 200 for operating a refrigerator appliance 100 is provided. Method 200 can be used to operate refrigerator appliance 100, or to operate any other suitable refrigerator. In this regard, for example, controller 164 may be configured for implementing method 200. However, it should be appreciated that the exemplary method 200 is discussed herein only to describe exemplary aspects of the present subject matter and is not intended to be limiting.

Referring now to FIG. 3, method 200 includes, at step 210, obtaining, or sampling, an audio input using a microphone (e.g., microphone 170) of an appliance (e.g., the refrigerator appliance 100). The audio input may include spoken words and phrases, nonverbal sounds, sounds of kitchen items being used, and the like. For example, the microphone 170 may continuously sample audio from around the refrigerator appliance (e.g., within the kitchen, dining room, or another adjacent area of a home). The controller 164 may determine there is no sound, or insufficient sound, to use within the audio input; thus, the controller 164 may discard (or overwrite) the audio input within a memory, or a local memory. The audio input may be sampled at regular intervals of a predetermined time duration. For example, the microphone 170 may sample the audio input every three to five seconds. Additionally, or alternatively, the controller 164 may determine there is sufficient sound sampled by the microphone; thus, the controller 164 may be configured to continue to step 220. “Sufficient” sound may equate to a loudness of a sound able to be heard by the microphone. For example, the microphone 170 may be able to detect sounds as quiet as about 20 decibels (dB) to about 40 dB, which may be as loud as, for example, a person whispering at about less than five feet away from the microphone 170. For example, the microphone 170 may hear someone verbally say, “Place these groceries neatly in the fridge.”

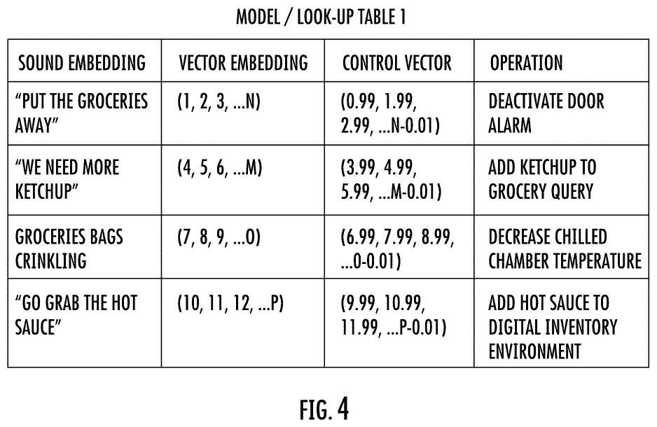

At step 220 of the method 200, the controller 164 may be configured to convert the audio input to a derived form. The derived form may include, for example, a spectrogram form of the audio heard by the microphone 170. A spectrogram is a visual representation of the spectrum of frequencies of a signal as it varies with time. Converting the audio input to a derived form (e.g., the spectrogram form) may allow the sound to be analyzed further as the derived form may include a visual form that has frequency values. For example, the heard phrase “place there groceries neatly in the fridge” may be converted to a spectrogram form in a coordinate plane illustrating various frequencies of the sounds that make up the phrase. Accordingly, step 230 of the method 200 includes inputting the derived form into a model. The model may include, for example, a look-up table (as illustrated in FIG. 4). The model may also include a formula that can input the derived form in as an independent variable. Furthermore, the model may use statistical regression analysis found empirically.

The look-up table of FIG. 4 is an example look-up table or model that may be used in the method 200. The look-up table includes a discrete first list of operations and a discrete second list of control vectors that correspond to the first list of operations. The look-up table may include, or store, a sound embedding of the audio input in a third discrete list. Furthermore, the look-up table may include, or store, a fourth discrete list of vector embeddings of the derived form of the audio inputs that correspond to the third discrete list of sound embeddings.

Step 240 of the method 200 includes assigning the derived form a vector embedding. For example, the spectrogram form example of the derived form may be assigned a vector embedding having about 300 to about 1000 values. As illustrated in FIG. 4, the vector embedding may be a vector having values across about 300 to about 1000 dimensions. For example, the phrase “place these groceries neatly in the fridge” may be assigned a vector embedding of [1.01, 2.01, 3.01, . . . n+0.01]. Derived forms of individual sounds heard by the microphone may be assigned wholly unique vector embeddings compared to entire phrases, or collective sounds, of the entire three to five second audio input. For example, the word “place” heard in isolation may have a vector embedding that may not overlap, or may not be near to, in multi-dimensional space with the vector embedding of the derived form of the phrase “place these groceries neatly in the fridge.”

Step 250 of method 200 includes matching the vector embedding of the derived form of the audio input to a control vector within a predetermined level of confidence within the model (e.g., within the look-up table). The control vector may be set by the designer, the manufacturer, the retailer, or the user. The control vector is a vector having values across about 300 to about 1000 dimensions, similar to the vector embedding. The vector embedding may overlap or be near to the control vector within a predetermined level of confidence. For example, the vector embedding may be about 90% the same as the control vector in multi-dimensional space. Additionally, or alternatively, the vector embedding may be about 95% the same as the control vector in multi-dimensional space. Additionally, or alternatively, the vector embedding may be about 99% the same as the control vector in multi-dimensional space. The level of confidence may be more than about 90%, more than about 95%, or more than about 99%. Additionally, the level of confidence may be set by, for example, the designer, the manufacturer, the retailer, or the user. In the case where the vector embedding is outside of the predetermined level of confidence from a control vector, the method may proceed directly to step 290. Step 290 of the method 200 includes discarding, or allowing to be overwritten, the audio input. Step 290 is discussed in more detail below.

At step 260 the method 200 includes executing an operation that corresponds to the control vector. The operation may include a refrigeration operation (e.g., altering temperature), a data management operation (e.g., altering a digital inventory environment), or the like. The digital inventory environment may include, for example, an index, or database, of items stored within the refrigerator appliance based on images, manually entered data, audio captured, or the like. For example, the vector embedding of the derived form of the audio input of “place these groceries neatly in the fridge” may be within the predetermined level of confidence of a control vector that corresponds to deactivating an alarm that would ordinarily active if the doors 128, 130 remains open for longer than a predetermined duration of time. For example, the doors 128, 130 being open for longer than about five minutes may ordinarily activate a speaker (not shown) that reminds a user to close the doors 128, 130; however, putting groceries into the refrigerator appliance 100 may require the doors 128, 130 to remain open longer than five minutes. Thus, the controller may deactivate the alarm for about 30 minutes based on the vector embedding being within the predetermined level of confidence of the control vector that corresponds to the specific operation of deactivating the alarm.

Furthermore, the controller 164 may execute the operation that corresponds to the control vector based on or more images captured by the cameras 172, 174. For example, the vector embedding may be within the predetermined level of confidence of a control vector that corresponds to altering the digital inventory environment, and the camera 172, 174 may capture an image that confirms an item should be added or removed from the digital inventory environment. Additionally, or alternatively, the cameras 172, 174 may capture images that would suggest an item should be added or removed from the digital inventory environment, but the vector embedding of the derived form of the audio input may suggest the digital inventory environment should not be altered. For example, the image may capture an item being removed from the refrigerator appliance 100, but the audio input may ultimately correspond to a determination that the item still exists in the digital inventory environment and is merely temporarily removed.

It is understood by one of ordinary skill in the art that deactivating a door alarm is not the only use for the presently described method 200 of the refrigerator appliance. For example, a vector embedding of derived form of an audio input may be within the predetermined level of confidence of a control vector that corresponds to operations that include at least one of temperature setting changes/queries, shopping list manipulation/queries, digital inventory environment information/queries, dispenser operations, cooking related questions (e.g., unit conversions, recipe information/queries, or other cooking or refrigeration related operations).

Step 270 of the method 200 includes providing an informative response to a user. Step 270 may occur in response to step 260. The response may include, for example, a notification that ingredients are stored in the digital inventory environment and included in a plurality of recipes of the dish. For example, the controller 164 may determine the user is to prepare a specific dish based on the vector embedding being within the predetermined level of confidence of a control vector that corresponds to an operation that determines the user is preparing, or is going to prepare, a specific dish. For example, the controller 164 may determine the user is going to make tacos; thus, the controller 164 may execute step 270 to provide the user with an informative response that may include a list of ingredients stored within the refrigerator appliance 100, or specifically items that are stored in a digital inventory environment, that are included in one or more recipes for tacos. Advantageously, this would remind users to use food items or ingredients that may otherwise expire if forgotten about. One of ordinary skill in the art understands that providing an informative response to a user may include information beyond recipes. For example, the informative response may include information related to the operation executed in step 260 (e.g., the door alarm is deactivated, items have been changed on a shopping list, items have been changed in the digital inventory environment, etc.).

Step 280 of the method 200 includes prompting the user for further information or confirmation. The controller 174 may prompt the user via display 166, a user input device 162, an external device 182, or the like. Additionally, or alternatively, step 280 may occur prior to step 260 based on step 250. For example, the vector embedding may be outside of the predetermined level of confidence relative to the control vector by less than a threshold difference. The threshold difference may be a range that is about 10% less than or greater than the predetermined level of confidence, about 5% less than greater than the predetermined level of confidence, or about 1% less than or greater than the predetermined level of confidence. If the vector embedding is within the threshold difference, but outside of the predetermined level of confidence, the controller 164 may execute step 280 to prompt the user for more information or confirmation.

For example, the vector embedding may be about 11% different than a control vector that corresponds to an operation that would deactivate the door alarm for 30 minutes. Instead of discarding the heard audio input, the controller 164 may execute step 280 to prompt the user for confirmation that the door alarm should indeed be deactivated for 30 minutes. Accordingly, the controller 164 may alter the vector embedding to align with the control vector or be within the predetermined level of confidence of the control vector based on the user confirmation being affirmative. Additionally, or alternatively, the controller 164 may execute step 280 even if the vector embedding is within the predetermined level of confidence of the control vector. Accordingly, the controller 164 may alter the control vector to reflect, or be closer to, the vector embedding based on the user confirmation being affirmative.

Furthermore, step 280 may include prompting the user for more information. For example, the controller 164 may determine the user is preparing, or going to prepare, a dish. The controller 164 may prompt the user for more information such as, for example, the style of the dish, sides of the dish, or the like. Another example of information the controller 164 may prompt the user for, may include asking if there should be additional items added to shopping list/query based on a determination that a specific item should be added based on the vector embedding being within the predetermined level of confidence of a control vector that adds the specific item to the shopping list/query. It is understood by one of ordinary skill in the art that the prompt for more information may include a request for more information related to data managed or refrigeration operations.

Step 290 of the method 200 includes discarding the audio input. The controller 164 may discard, or overwrite, the audio input based on the operation successfully being executed in step 250. For example, the operation in step 250 may be to deactivate the door alarm for 30 minutes, and the audio input may no longer be needed thereafter. Additionally, or alternatively, the controller 164 may discard the audio input based on receiving confirmation from the user at step 280. The audio input may be constantly overwritten by the next iteration of the method 200 being executed. Additionally, or alternatively, the audio input may be discarded without being saved externally via the external network 180.

Advantageously, the refrigerator appliance described herein allows a user to speak or make sounds that ultimately allow the refrigerator appliance to carry out operations. Users may not have to bother with speaking directly to the refrigerator appliance with a command. Users can speak or make sounds near the refrigerator appliance and come to expect appropriate operations to be carried out. The presently described refrigerator appliance makes cooking easier and interaction more direct without needing to provide explicit instructions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating an appliance, the method comprising:
sampling, via a microphone, an audio input;
converting the audio input to a derived form;
inputting the derived form into a model, wherein the model assigns the derived form a vector embedding;
matching the vector embedding to a control vector within a predetermined level of confidence; and
executing an operation, wherein the operation corresponds to the control vector.

2. The method of claim 1, wherein the operation and the control vector are stored in a look-up table that includes a discrete first list of operations and a discrete second list of control vectors corresponding to the first list of operations.

3. The method of claim 1, wherein the operation includes a refrigeration operation.

4. The method of claim 1, wherein the operation includes a data management operation.

5. The method of claim 4, wherein the data management operation includes altering a digital inventory environment.

6. The method of claim 5, further comprising:
determining a dish is to be prepared; and
notifying a user of ingredients that are stored in the digital inventory environment and included in a plurality of recipes of the dish.

7. The method of claim 5, wherein the digital inventory environment is altered based on the audio input and a captured image.

8. The method of claim 1, further comprising:
discarding the audio input in response to the vector embedding being outside the predetermined level of confidence relative to the control vector.

9. The method of claim 1, further comprising:
discarding the audio input in response to executing the operation.

10. The method of claim 1, further comprising:
providing an informative response to a user; and
prompting the user for further information or confirmation.

11. The method of claim 10 further comprising:
altering the control vector to be closer in value to the vector embedding based on confirmation from the user.

12. The method of claim 1, wherein the derived form includes a spectrogram form.

13. An appliance comprising:
a cabinet;
a microphone mounted to the cabinet; and
a controller communicatively coupled with the microphone, the controller being configured to:
receive, via a microphone, an audio input;
convert the audio input to a derived form;
input the derived form into a model, wherein the model assigns the derived form a vector embedding;
match the vector embedding to a control vector within a predetermined level of confidence; and
execute an operation, wherein the operation corresponds to the control vector.

14. The appliance of claim 13, wherein the operation and the control vector are stored in a look-up table that includes a discrete first list of operations and a discrete second list of control vectors corresponding to the first list of operations.

15. The appliance of claim 13, wherein the operation includes a refrigeration operation.

16. The appliance of claim 13, wherein the operation includes a data management operation.

17. The appliance of claim 16, wherein the data management operation includes altering a digital inventory environment.

18. The appliance of claim 13, wherein the controller is further configured to:
discard the audio input in response to at least one of the vector embedding being outside the predetermined level of confidence relative to the control vector, or the operation being executed by the controller.

19. The appliance of claim 13, further comprising:
an indicator mounted on the cabinet;
a user input device mounted on the cabinet; and
wherein the controller is further configured to:
provide an informative response to a user at the indicator; and
prompt the user for further information or confirmation via the user input device.

20. The appliance of claim 19, wherein the controller is further configured to:
alter the control vector to be closer in value to the vector embedding based on confirmation from the user.
